(19) United States
(12) Patent Application Publication
(10) Pub. No.: US 2011/0193777 A1
(43) Pub. Date: Aug. 11, 2011

(54) MULTIPLE POINTER AMBIGUITY AND OCCLUSION RESOLUTION

(75) Inventors: Ye Zhou, Calgary (CA); Daniel P. McReynolds, Calgary (CA); Brian L.W. Howse, Calgary (CA); Brinda Prasad, Calgary (CA); Grant H. McGibney, Calgary (CA)

(73) Assignee: SMART TECHNOLOGIES ULC

(21) Appl. No.: 12/996,188

(22) PCT Filed: Jun. 5, 2009
(86) PCT No.: PCT/CA09/00773

§ 371 Date: Feb. 28, 2011

Related U.S. Application Data
(60) Provisional application No. 61/059,183, filed on Jun. 5, 2008.

(51) Int. Cl. G06F 3/033

(52) U.S. Cl. 345/157

(57) ABSTRACT

A method of resolving ambiguities between at least two pointers in an interactive input system comprises capturing images of a region of interest, processing image data to determine a plurality of potential targets for the at least two pointers within the region of interest and a current target location for each potential target, the plurality of potential targets comprising real and phantom targets, tracking each potential target within the region of interest and calculating a predicted target location for each potential target and determining a pointer path associated at least with each real target.

### FIELD OF THE INVENTION

The present invention relates to input systems and in particular, to an interactive input system employing reduced imaging device hardware that is able to resolve pointer ambiguity and occlusion and to a pointer ambiguity and occlusion resolution method.

### BACKGROUND OF THE INVENTION

Interactive input systems that allow users to inject input such as digital ink, mouse events etc. into an application program using an active pointer (eg. a pointer that emits light, sound or other signal), a passive pointer (eg. a finger, cylinder or other object) or other suitable input device such as for example, a mouse or trackball, are well known. These interactive input systems include but are not limited to: touch systems comprising touch panels employing analog resistive or machine vision technology to register pointer input such as those disclosed in U.S. Pat. Nos. 5,448,263; 6,141,000; 6,337,681; 6,747,636; 6,803,906; 7,232,986; 7,236,162; and 7,274,356 and in U.S. Patent Application Publication No. 2004/0179001 assigned to SMART Technologies ULC of Calgary, Alberta, Canada, assignee of the subject application, the contents of which are incorporated by reference; touch systems comprising touch panels employing electromagnetic, capacitive, acoustic or other technologies to register pointer input; tablet personal computers (PCs); laptop PCs; personal digital assistants (PDAs); and other similar devices.

Above-incorporated U.S. Pat. No. 6,803,906 to Morrison et al. discloses a touch system that employs machine vision to detect pointer interaction with a touch surface on which a computer-generated image is presented. A rectangular bezel or frame surrounds the touch surface and supports digital cameras at its four corners. The digital cameras have overlapping fields of view that encompass and look generally across the touch surface. The digital cameras acquire images looking across the touch surface from different vantages and generate image data. Image data acquired by the digital cameras is processed by on-board digital signal processors to determine if a pointer exists in the captured image data. When it is determined that a pointer exists in the captured image data, the digital signal processors convey pointer characteristic data to a master controller, which in turn processes the pointer characteristic data to determine the location of the pointer in (x,y) coordinates relative to the touch surface using triangulation. The pointer coordinates are then conveyed to a computer executing one or more application programs. The computer uses the pointer coordinates to update the computer-generated image that is presented on the touch surface. Pointer contacts on the touch surface can therefore be recorded as writing or drawing or used to control execution of application programs executed by the computer.

In environments where the touch surface is small, more often than not, users interact with the touch surface one at a time, typically using a single pointer. In situations where the touch surface is large, as described in U.S. patent application Ser. No. 10/750,219 to Hill et al., assigned to SMART Technologies ULC, the content of which is incorporated by reference, multiple users may interact with the touch surface simultaneously.

As will be appreciated, in machine vision touch systems, when a single pointer is in the fields of view of multiple imaging devices, the position of the pointer in (x,y) coordinates relative to the touch surface typically can be readily computed using triangulation. Difficulties are however encountered when multiple pointers are in the fields of view of multiple imaging devices as a result of pointer ambiguity and occlusion. Ambiguity arises when multiple pointers in the images captured by the imaging devices cannot be differentiated. In such cases, during triangulation a number of possible positions for the pointers can be computed but no information exists to allow the correct pointer positions to be selected. Occlusion occurs when one pointer occludes another pointer in the field of view of an imaging device. In these instances, the image captured by the imaging device includes only one pointer. As a result, the correct positions of the pointers relative to the touch surface cannot be computed using triangulation. Increasing the number of imaging devices allows pointer ambiguity and occlusion to be resolved but this of course results in increased touch system cost and complexity.

It is therefore an object of the present invention to provide a novel interactive input system and a novel pointer ambiguity and occlusion resolution method.

### SUMMARY OF THE INVENTION

Accordingly, in one aspect there is provided a method of resolving ambiguities between at least two pointers in an interactive input system comprising:

capturing images of a region of interest;

processing image data to determine a plurality of potential targets for said at least two pointers within the region of interest and a current target location for each potential target, said plurality of potential targets comprising real and phantom targets;

tracking each potential target within said region of interest and calculating a predicted target location for each potential target; and

determining a pointer path associated at least with each real target.

According to another aspect there is provided a method of resolving ambiguities between pointers in an interactive input system when at least one pointer is brought into a region of interest where at least one pointer already exists therein, the method comprising:

determining real and phantom targets associated with each pointer;

setting a real error function associated with said real targets;

setting a phantom error function associated with said phantom targets, wherein said phantom error function is set to a value different from said real error function; and

tracking and resolving each pointer based on their associated error functions.

According to another aspect there is provided a method of resolving ambiguities between pointers in an interactive input system when at least two pointers are brought into a region of interest simultaneously:

determining real and phantom targets associated with each pointer contact;

setting error functions associated with each target; and

tracking and resolving each pointer contact through their associated error functions.

Accordingly, in one aspect there is provided in an interactive input system comprising:

at least two imaging devices having at least partially overlapping fields of view encompassing a region of interest; and

processing structure processing image data acquired by the imaging devices to track the position of at least two pointers within said region of interest and resolve ambiguities between the pointers.

### BRIEF DESCRIPTION OF THE DRAWINGS

Embodiments will now be described more fully with reference to the accompanying drawings in which:

FIG. 1 is a front plan view of an interactive input system;

FIG. 2 is a schematic diagram of the interactive input system of FIG. 1;

FIG. 3 is an enlarged front plan view of a corner of a touch panel of the interactive input system of FIGS. 1 and 2;

FIG. 4A is a front plan view of the touch panel showing two pointers in contact with the touch panel together with two phantom pointers thereby to highlight pointer ambiguity;

FIG. 4B shows image frames acquired by the digital camera of the interactive input system looking generally across the touch panel of FIG. 4A;

FIG. 5 is a front plan view of the touch panel showing two pointers in contact with the touch panel thereby to highlight pointer occlusion;

FIG. 5B shows image frames acquired by the digital cameras of the interactive input system looking generally across the touch panel of FIG. 5A;

FIG. 6 shows possible states of pointers in captured image frames;

FIGS. 7A and 7B are flow diagrams showing the steps performed during tracking of multiple pointers;

FIGS. 8A and 8B are flow diagrams showing the steps performed during tracking of multiple pointers; and

FIGS. 9A to 9I show tracking of multiple pointers moving across the touch surface of the touch panel.

### DETAILED DESCRIPTION OF THE EMBODIMENTS

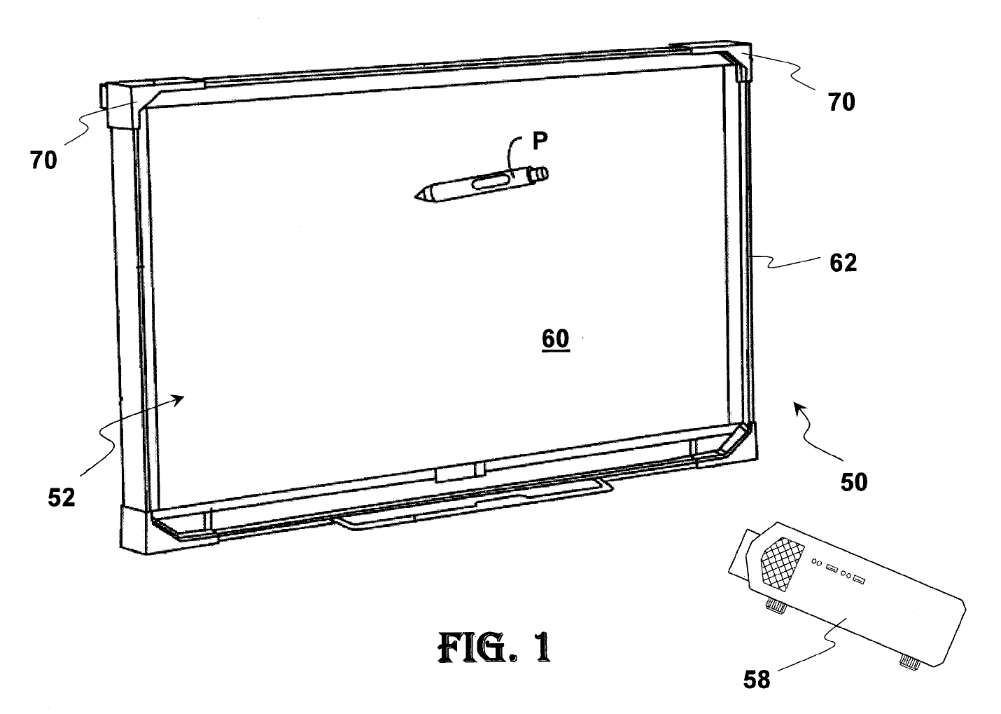

Referring now to FIGS. 1 to 3, an interactive input system is shown and is generally identified by reference numeral 50. Interactive input system 50 is similar to that disclosed in above-incorporated U.S. Pat. No. 6,803,906, assigned to SMART Technologies ULC of Calgary, Alberta, assignee of the subject application.

As can be seen, interactive input system 50 comprises a touch panel 52 coupled to a digital signal processor (DSP)-based master controller 54. Master controller 54 is also coupled to a computer 56. Computer 56 executes one or more application programs and provides computer-generated image output to an image generating device 58. Image generating device 58 in turn generates a computer-generated image that is presented on the touch surface 60 of the touch screen 52. The touch panel 52, master controller 54, computer 56 and image generating device 58 allow pointer contacts on the touch surface 60 to be recorded as writing or drawing or used to control execution of application programs executed by the computer 56.

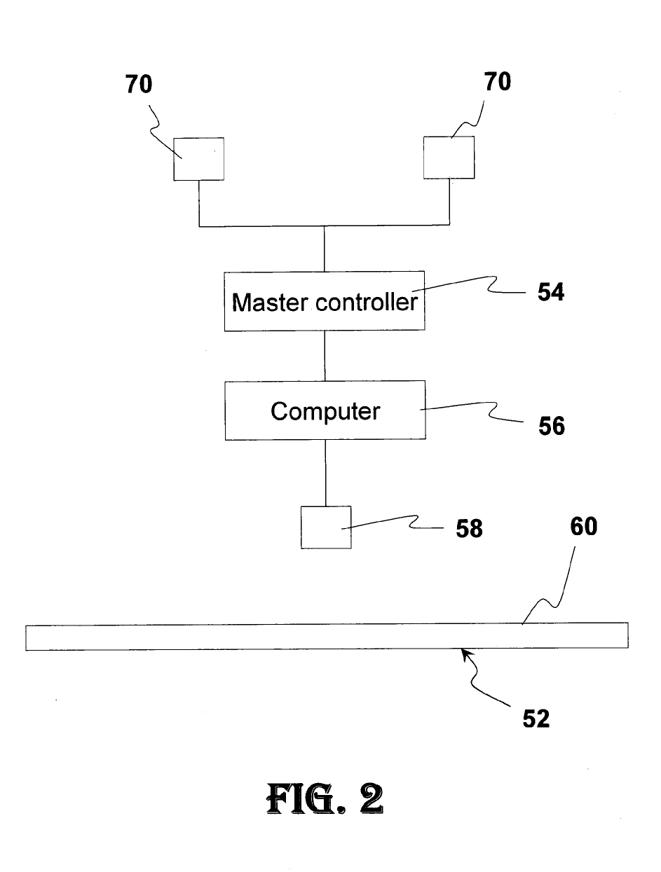

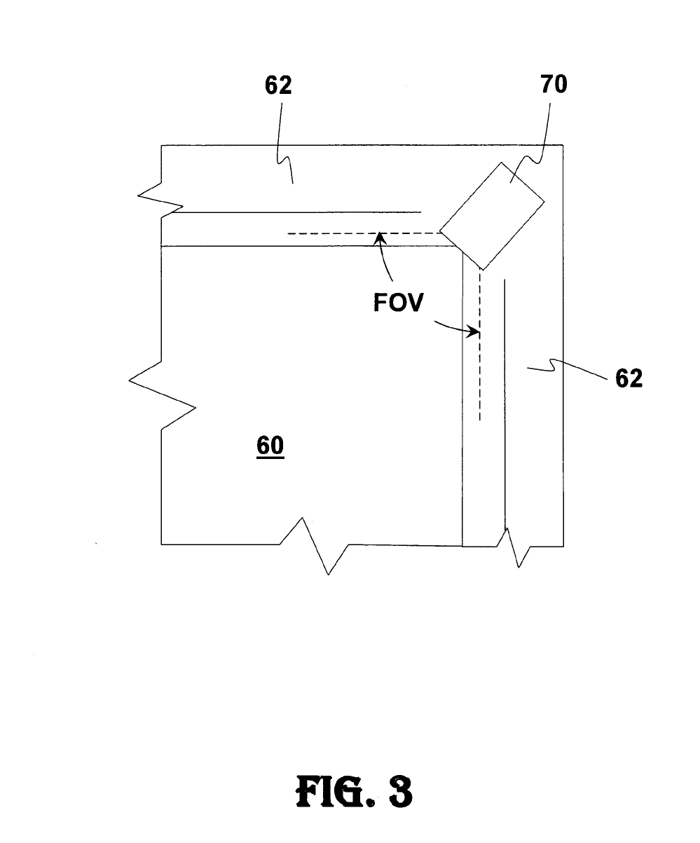

The touch surface 60 is bordered by a bezel or frame 62 similar to that disclosed in U.S. Pat. No. 6,972,401 to Akitt et al. issued on Dec. 6, 2005, assigned to SMART Technologies, ULC, assignee of the subject application, the content of which is incorporated herein by reference. A DSP-based digital camera 70 having on-board processing capabilities, best seen in FIGS. 2 and 3, is positioned adjacent each top corner of the touch surface 60 and is accommodated by the bezel 62. In this embodiment, each digital camera 70 comprises an image sensor that looks generally across the touch surface 60 and a processing unit (not shown) communicating with the image sensor. The optical axis of each image sensor is aimed generally toward the opposing corner of the touch surface and in this example, is in line with a diagonal of the touch surface 60. Thus, the optical axis of each image sensor bisects the diagonally opposite corner of the touch surface 60.

During operation of the touch system 50, the image sensor of each digital camera 70 looks across the touch surface 60 and acquires image frames. For each digital camera 70, image data acquired by its image sensor is processed by the processing unit of the digital camera to determine if one or more pointers is/are believed to exist in each captured image frame. When one or more pointers is/are determined to exist in the captured image frame, pointer characteristic data is derived from that captured image frame identifying the pointer position(s) in the captured image frame.

The pointer characteristic data derived by each digital camera 70 is then conveyed to the master controller 54, which in turn processes the pointer characteristic data in a manner to allow the location of the pointer(s) in (x,y) coordinates relative to the touch surface 60 to be calculated.

The pointer coordinate data is then reported to the computer 56, which in turn records the pointer coordinate data as writing or drawing if the pointer contact is a write event or injects the pointer coordinate data into the active application program being run by the computer 56 if the pointer contact is a mouse event. As mentioned above, the computer 56 also updates the image data conveyed to the image generating device 58 so that the image presented on the touch surface 60 reflects the pointer activity.

When a single pointer exists in the image frames captured by the digital cameras 70, the location of the pointer in (x,y) coordinates relative to the touch surface 60 can be readily computed using triangulation. When multiple pointers exist in the image frames captured by the digital cameras 70, computing the positions of the pointers in (x,y) coordinates relative to the touch surface 60 is more challenging as a result of the pointer ambiguity and occlusion issues discussed previously.

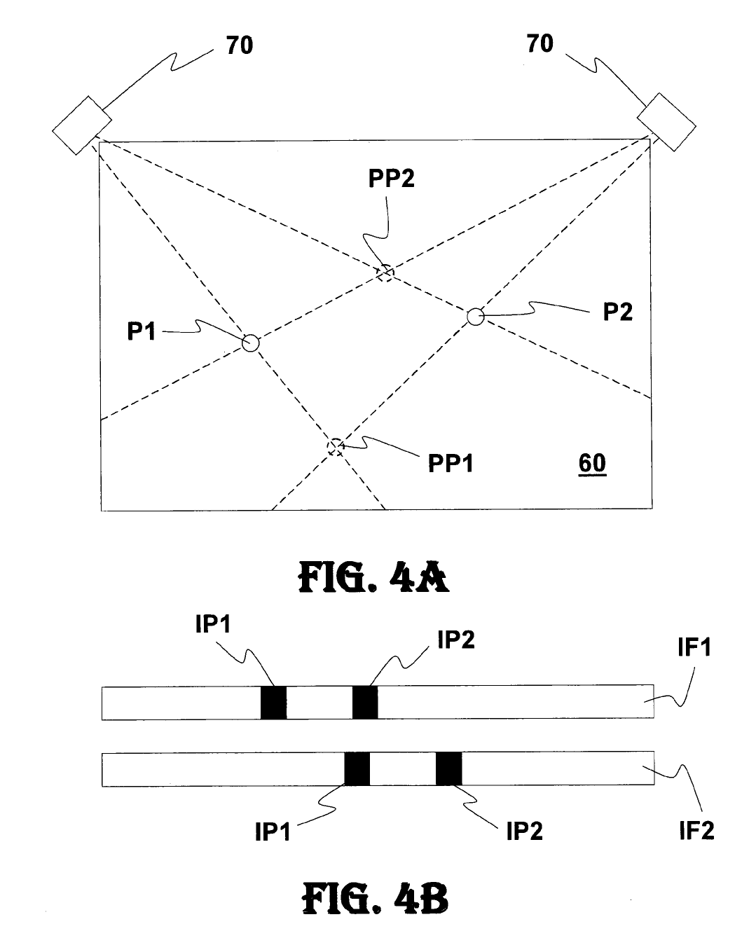

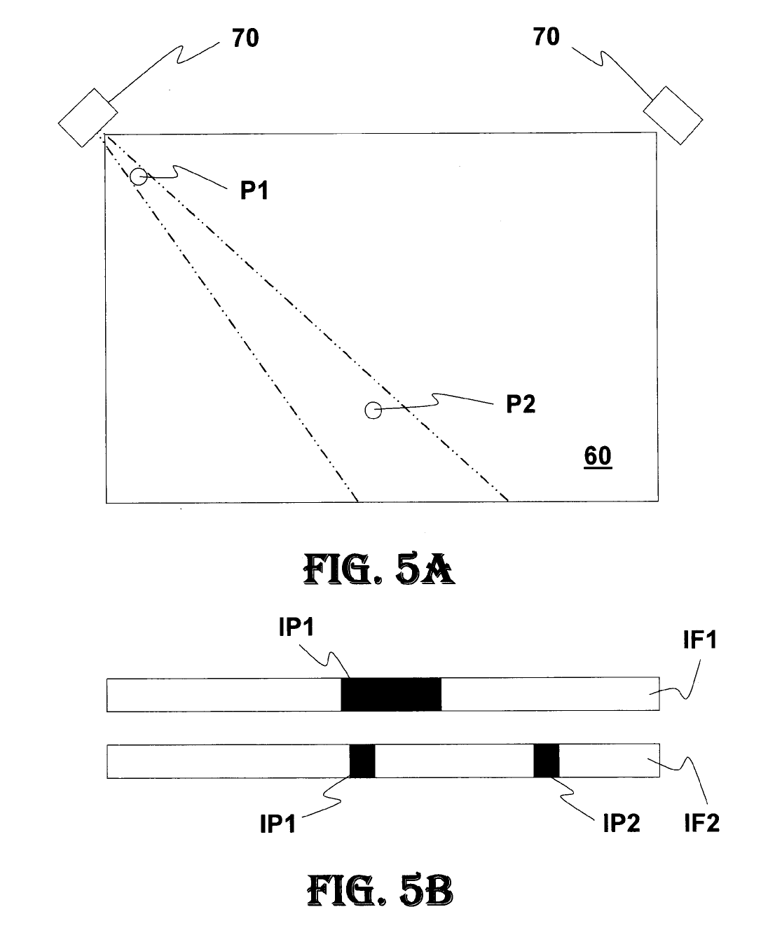

FIGS. 4A, 4B and 5A and 5B illustrate the pointer ambiguity and occlusion issues that arise in the interactive input system 50 as a result of the use of only two digital cameras 70. In particular, FIG. 4A illustrates pointer ambiguity. As can be seen, in this example two pointers P1 and P2 are in contact with the touch surface 60 at different locations and are within the fields of view of the digital cameras 70. FIG. 4B shows the image frame IF1 captured by the top left digital camera 70 and the image frame IF2 captured by the top right digital camera 70. Each image frame contains an image IP1 of the pointer P1 and an image IP2 of the pointer P2. Unless the pointers P1 and P2 have distinctive markings to allow them to be differentiated, the images of the pointers in each image frame IF1 and IF2 may be confused leading possibly to incorrect triangulation results (i.e. phantom pointers) as identified by the dotted lines PP1 and PP2.

FIGS. 5A and 5B illustrate pointer occlusion. In this example pointer P1 occludes pointer P2 in the field of view of the top left digital camera 70. As a result, the image frame IF1 captured by the top left digital camera 70 includes an image IP1 of only pointer P1.

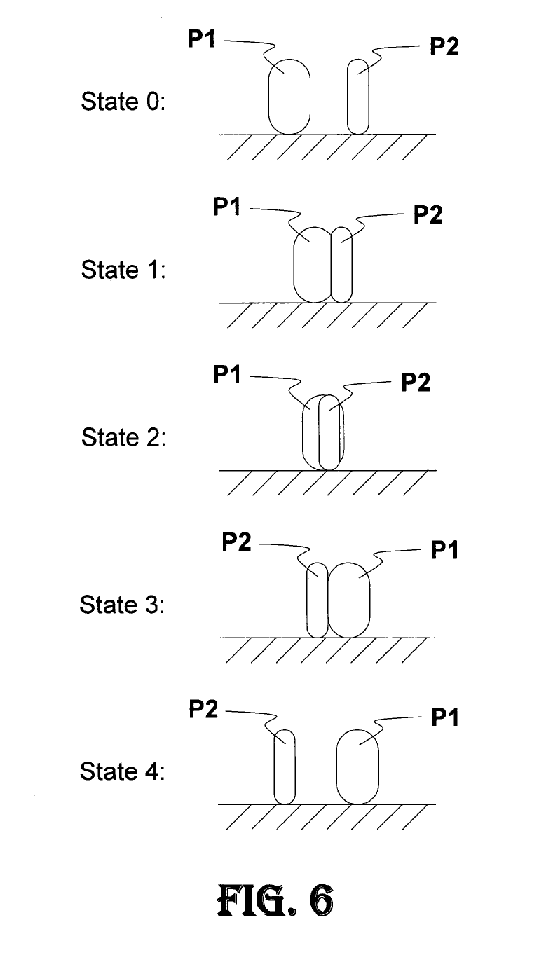

When two pointers P1 and P2 are in the fields of view of the digital cameras 70, the pointers may take one of the five possible states in the image frames as shown in FIG. 6. In states 0 and 4, the images of the pointers in the image frames are separate and distinct. In states 1 and 3, the images of the pointers in the image frames are merged. In state 2, the image of only one pointer appears in the image frames due to occlusion. To deal with the pointer ambiguity and occlusion issues, the interactive input system 50 employs a pointer ambiguity and occlusion resolution method to enable effective tracking of multiple pointers even though only two digital cameras 70 are used, as will now be described.

In order to track multiple pointers that are in the fields of view of the digital cameras 70, the master controller 54 executes a pointer ambiguity and occlusion resolution routine comprising a plurality of modules (in this case four (4)), namely a target birth module, a target tracking module, a state estimation module, and a blind tracking module. The target birth module is used when a pointer first appears in an image frame. The target birth module creates targets that are locations on the touch surface 60 that could potentially represent the real location of a pointer, based on the information in the digital camera image frames. Targets may be “real” targets that correspond to an actual pointer location, or “phantom” targets, that do not correspond to an actual pointer location. The output of the target birth module seeds the tracking and state estimation modules. The target tracking module employs a mathematical model that follows the pointer(s) on the touch surface 60 and makes a prediction as to where the pointer(s) will be in the next image frame. The state estimation module takes the output from the target birth and target tracking modules, and pointer characteristic information from the digital camera image frames, and tries to determine the pointer locations and the digital camera states corresponding to the pointer locations on each image frame. The state estimation module is also responsible for detecting and correcting errors to make sure that the pointer position estimation is the best possible estimation based on all currently available pointer data. The blind tracking module is initiated when one pointer becomes obscured by another pointer for a long period of time.

During execution of the pointer ambiguity and occlusion resolution routine, one of two procedures is followed depending on the pointer scenario. In particular, a first procedure is followed when a single pointer P1 is brought into contact with the touch surface 60 and a second pointer P2 is later brought into contact with the touch surface 60 while the first pointer P1 remains in contact with the touch surface 60. A second procedure is followed when two pointers P1 and P2 are brought into contact with the touch surface 60 generally simultaneously.

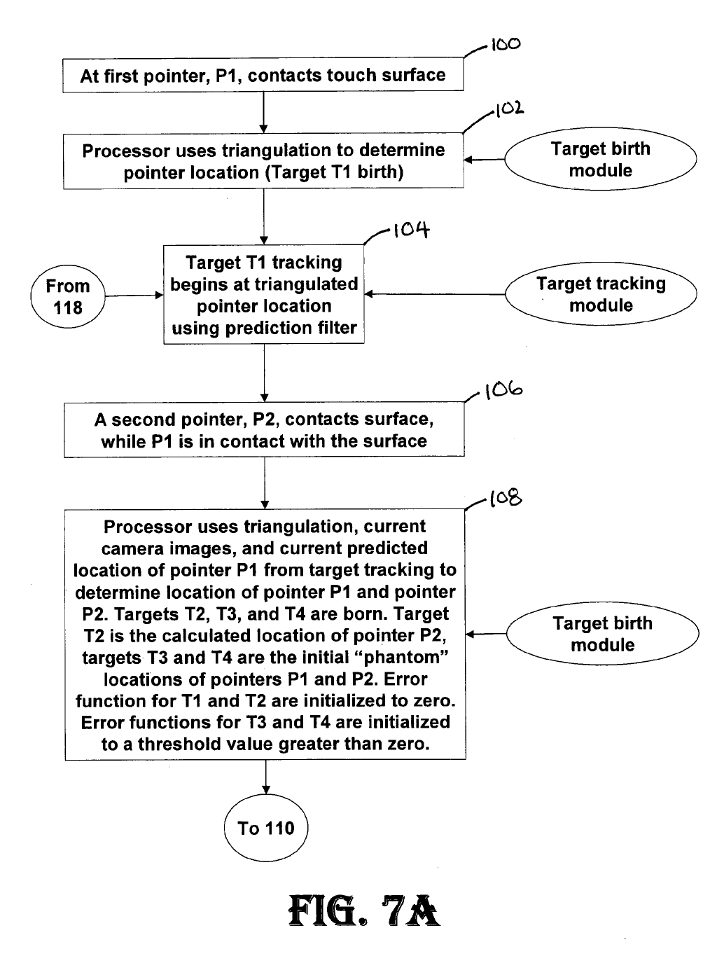

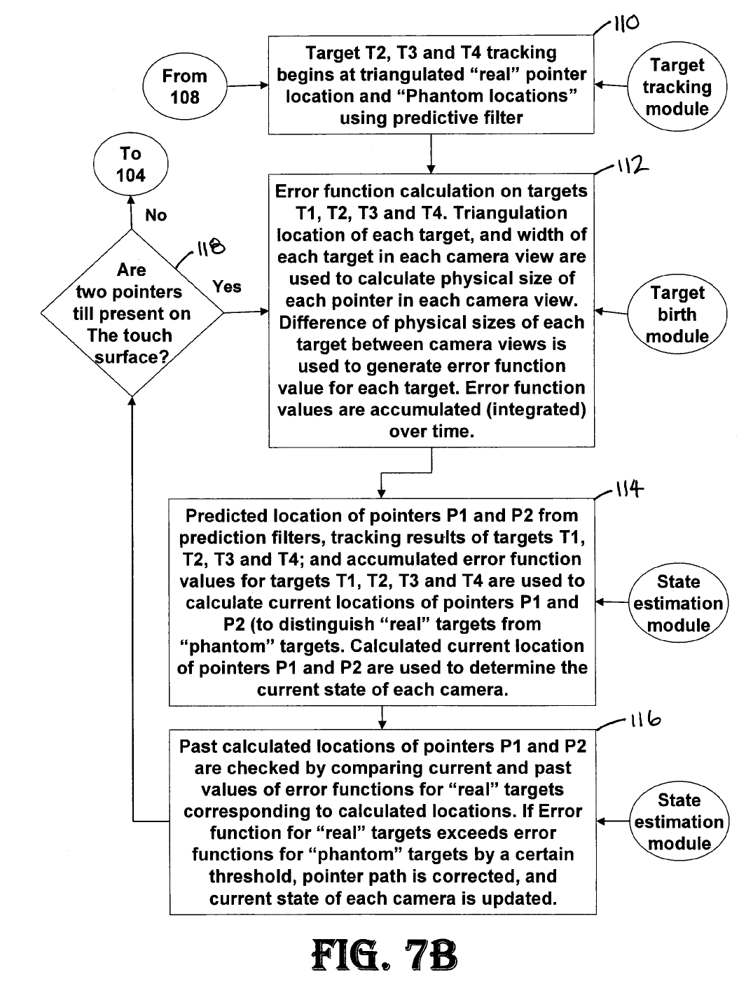

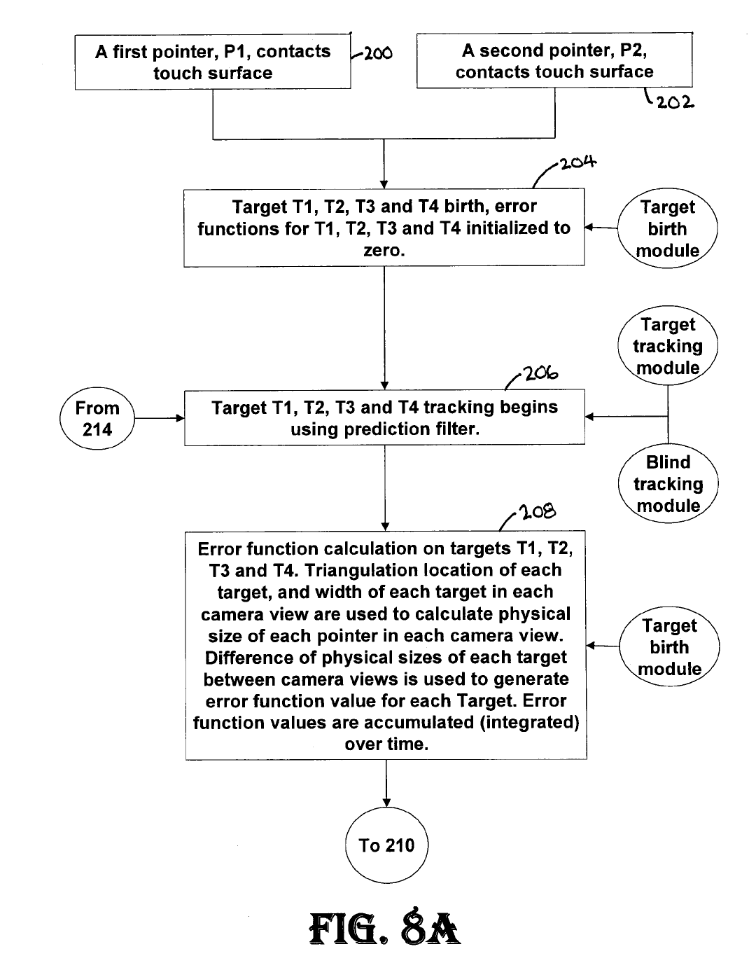

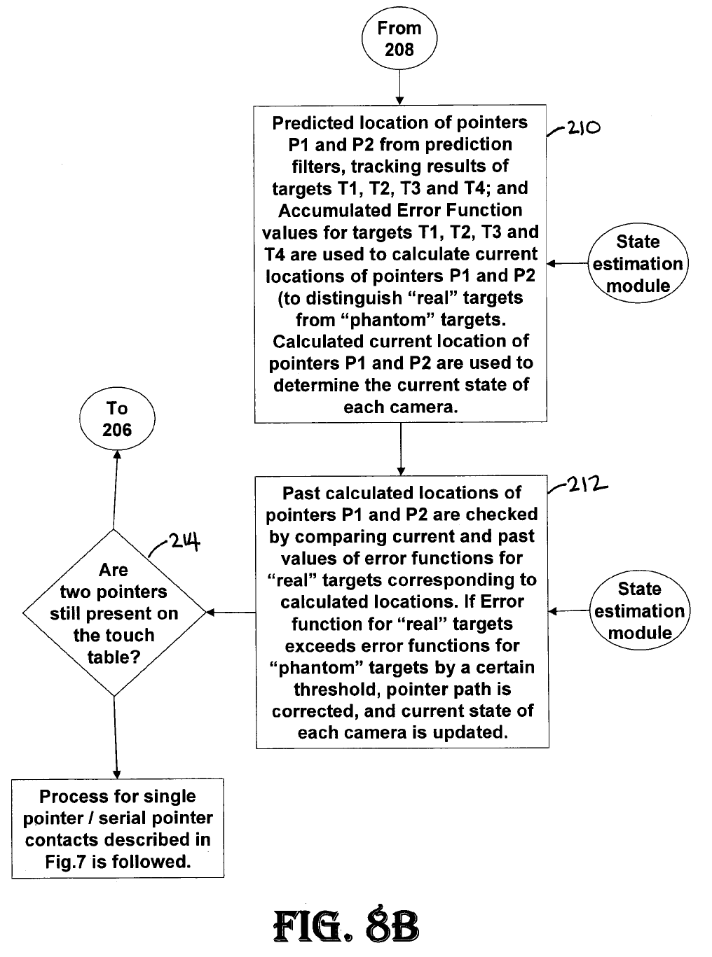

FIGS. 7A, 7B, 8A and 8B are flow diagrams showing the steps performed during the first and second procedures in the two pointer scenarios. FIGS. 7A and 7B consider the scenario where a single pointer P1 contacts the touch surface 60 first, and a second pointer P2 contacts the touch surface 60 later, while the first pointer P1 remains in contact with the touch surface 60. FIGS. 8A and 8B consider the scenario where two pointers P1 and P2 contact the touch surface 60 generally simultaneously.

With respect to the first scenario, the procedure begins in FIG. 7A when a first pointer P1 contacts the touch surface 60 (step 100). Since there is only one pointer in contact with the touch surface 60, and there are two camera image frames, triangulation can be used by the master controller 54 without ambiguity to determine the pointer location in (x,y) coordinates relative to the touch surface 60 (step 102). A target T1 corresponding to the location of pointer P1 on the touch surface 60 is also “born” using the target birth module. After target T1 is “born”, the location of target T1 is tracked using the target tracking module (step 104). The target tracking module in this embodiment is based on a predictive filter. The predictive filter may be a simple linear predictive filter, any type of Kalman filter, or any other type of predictive filter or system estimator. The Kalman filter, known to those skilled in the art, has the property that it not only monitors the state of what it is tracking (position, velocity, etc.), but it also estimates how well its underlying model is working. If a user is drawing a predictable object (say a straight line) with the pointer, then the model determines that its fit is good and resists errors caused by minor variations (noise). If the user then switches to a less predictable style (for example, small text), then the Kalman filter will automatically adjust its response to be more responsive to sudden changes. Using a predictive filter to track target T1 in the absence of other targets is optional—the results of the predictive filter are useful when multiple pointers interact with the touch surface 60.

As shown in FIG. 7A, when a second pointer P2 contacts the touch surface 60 while the first pointer P1 remains in contact with the touch surface 60 (step 106), additional targets T2, T3, and T4 are “born” using the target birth module (step 108). Target T2 corresponds to the initial location of the pointer P2 calculated using triangulation techniques known in the art, and using the predicted value of target T1 at the time pointer P2 contacts the touch surface 60. Since the location of target T1 can be unambiguously determined up to the time immediately before pointer P2 contacts the touch surface 60, the predicted location of target T1 allows the location of target T2 to be determined, again using triangulation. Targets T3 and T4 are also “born” at the time when pointer P2 contacts the touch surface 60. Targets T3 and T4 are phantom targets that represent alternative pointer locations that could represent the actual pointer locations based on the current image frame data, but that are initially assumed to be “phantom” locations based on the predicted location of target T1. Error functions are initialized to zero for targets T1 and T2, and error functions are initiated to a threshold value greater than zero for targets T3 and T4 at the time pointer P2 contacts the touch surface 60. The error functions are set higher for targets T3 and T4 because it can be determined with reasonable accuracy that targets T3 and T4 are the phantom targets from the known location of target T1 immediately before pointer P2 contacts the touch surface 60. The error functions are further described in the following paragraphs.

As shown in FIG. 7B, after pointer P2 contacts the touch surface 60, tracking of targets T2, T3, T4 using the predictive filter as previously described begins (step 110) and tracking of target T1 continues using the target tracking module.

As shown in FIG. 7B, after pointer P2 contacts the touch surface 60 and the error functions for all targets have been initialized, the error function calculation for each target starts (step 112). The triangulated location of each target and the width of each target in each digital camera image frame are used to calculate the physical size of each pointer in each digital camera image frame. Alternatively, other properties of the pointer could be used such as for example pointer shape, intensity level, color, etc. The error function for each target is the difference of the physical sizes of the target calculated for each digital camera image frame. The error function values are accumulated (integrated) over time and error function values are calculated for each target using a target birth testing component of the target birth module. Error functions are reset to zero whenever two pointers merge in one camera view. Error functions may also be forced to a state where an error correction never occurs by setting one error function value extremely high. This occurs during a reference camera change (described later) to lock in a solution until the next pointer merge.

As shown in FIG. 7B, the predicted target locations from the target tracking module, the current target locations from the target tracking module, and the accumulated error function values for all targets from the target birth module are then used to determine the locations of pointers P1 and P2, thereby distinguishing the “real” targets from the “phantom” targets (step 114). Calculated current locations of pointers P1 and P2 are used to determine the state of each digital camera 70. The digital camera states may be used to assist in calculating the current locations of pointers P1 and P2. As mentioned previously, FIG. 6 shows the digital camera states 0 to 4. Camera states 0 and 4 are more common (especially on large touch surfaces 60) and the two pointers are clearly separated. The state number identifies which pointer comes first (disambiguation). In states 1 and 3, the two pointers have merged into one object, but one clean edge can still be seen from each pointer. Only one pointer is reported from the digital camera 70. The state number in this case identifies which edge belongs to which pointer (disentanglement). State 2 is a special case where one pointer completely occludes the other. As will be appreciated, if the state is known at all times then both pointers can be tracked. The exception is state 2, where one pointer occludes the other; however the results of the predictive filter can be used to predict the location of the occluded pointer. The state estimation module distinguishes the “real” targets from “phantom” targets and determines the digital camera states.

As shown in FIG. 7B, past calculated locations of pointers P1 and P2 are checked by comparing if current and past values of the accumulated error functions for the “real” targets. If the accumulated error function for a “real” target exceeds the accumulated error function for a “phantom” target by a certain threshold, the pointer path of the real target is corrected such that it corresponds to the path of the “phantom” target with the lower accumulated error function, and the state of each digital camera 70 is updated (step 116).

The digital camera states and results of the predictive filter may also be used for error correction. For example, the transition from state 0 to state 1 to state 2 to state 3 to state 4 may be more likely than the transition from state 0 to state 4, to state 2, to state 3, and this likelihood may be used for error correction. This is a maximum likelihood problem where error metrics are applied to every reasonable state path combination and the state path combination with the least errors is designated as the most likely. The direct implementation of maximum likelihood becomes exponentially harder as the time that the pointers stay merged increases. In order to overcome this problem, the well known Viterbi optimization algorithm can be employed to keep track of only five paths regardless of how long the pointers stay merged. Error correction will occur back to the point when the error function was reset.

When a small pointer crosses a larger pointer, that pointer in one digital camera view may be lost for a number of image frames (possibly many). If it is only a small number of image frames (say 1 to 3), then this is not a problem as predicted pointer positions can be used for the missing data. If the pointers merge together in both views, it means that they are very close together on the touch surface 60 (almost touching) and they are treated as a single pointer. The other digital camera view will still be giving valid pointer data and will not need to be predicted.

In the rare case where a digital camera 70 is in state 2 for an extended period of time, the target tracking module may require interpolation in addition to the results of the predictive filters. In this instance, the blind tracking module is invoked. In one mode, the occluded target is reported for as long as it can be seen in the other digital camera view. For the missing data, the middle of the bigger pointer that is known may be used. This technique works best for gesture control. For example, if a gesture is input and both pointers are moving along the sight line of one digital camera 70, then the missing data is not important. All of the information that is required comes from the non-occluded digital camera view. In an alternative mode, reporting information about the occluded target is inhibited until the pointer reappears separate from the bigger pointer. The missing data can then be smoothly interpolated. Although this may result in a noticeable latency glitch, this technique works better for an ink scenario. The current functionality of the pointers (inking, erasing, or pointing) may also be used for error correction or disambiguation.

As shown in FIG. 7B, the process of tracking the targets, calculating error functions, and calculating and correcting the “real” and “phantom” target locations continues until there are no longer multiple pointers in contact with the touch surface 60 (step 118). When a single pointer is in contact with the touch surface 60, triangulation resumes and multiple target tracking, error function calculation, “real” target calculation and correction, and digital camera state tracking are no longer required. By reducing the number of calculations, the interactive input system 50 becomes more responsive during a single pointer state.

FIGS. 8A and 8B show the procedure that is followed when two pointers P1 and P2 contact the touch surface 60 generally simultaneously. When a first pointer P1 and a second pointer P2 contact the touch surface 60 simultaneously (steps 200 and 202), targets T1, T2, T3, and T4 are “born” using the target birth module (step 204). Error functions for targets T1, T2, T3, and T4 are all initialized to zero in this scenario since there is no previous tracking data for the targets to indicate which targets may be “phantom” targets. Following target birth, target tracking using the predictive filter as previously described begins using the target tracking module (step 206).

As shown in FIG. 8A, after target tracking begins, error function calculation as previously described begins for all the targets (step 208). In FIG. 8B, predicted locations of pointers P1 and P2 from predictive filters, tracking results of targets T1, T2, T3, and T4, and accumulated error function values for targets T1, T2, T3, and T4 are used to calculate the current locations of the pointers P1 and P2 (eg. to distinguish “real” targets from “phantom” targets) (step 210). Calculated current locations of the pointers P1 and P2 are used to determine the current state of each digital camera 70. Pointer location calculation and digital camera state estimation are performed using the state estimation module.

As shown in FIG. 8B, past calculated locations of pointers P1 and P2 are compared to current and past values of error functions for “real” targets corresponding to the calculated pointer locations (step 212). If the accumulated error function for one or more “real” targets exceeds the accumulated error function for one or more “phantom” targets by a certain threshold, the relevant pointer paths are corrected, and the current state of each digital camera 70 is updated. As previously described, past digital camera states may also be used to perform error correction. The above procedure is performed for as long as two pointers remain within the fields of view of the digital cameras 70 (step 214).

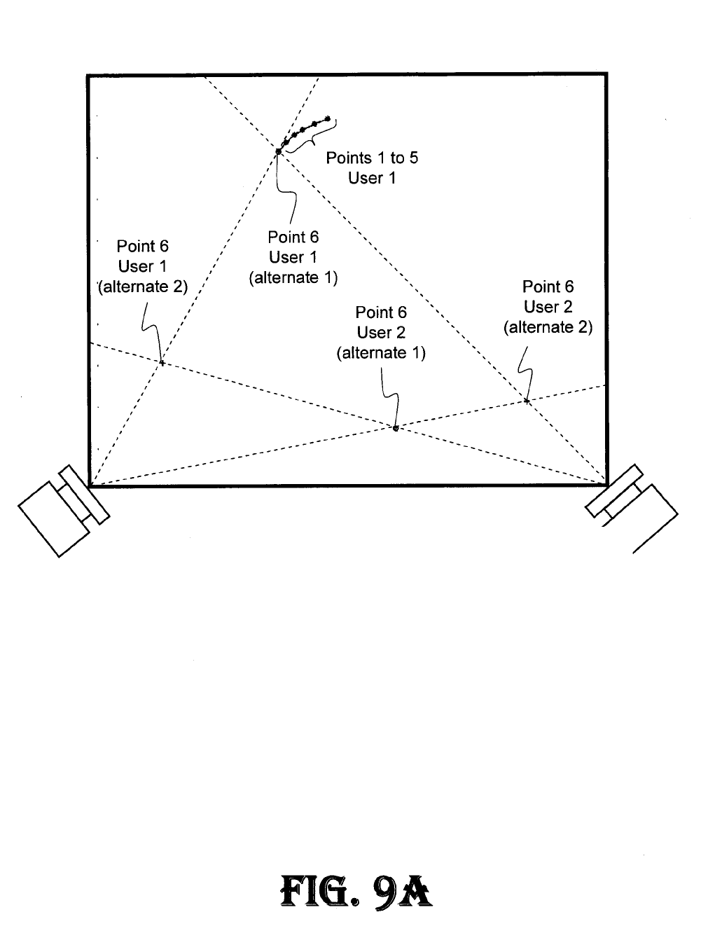

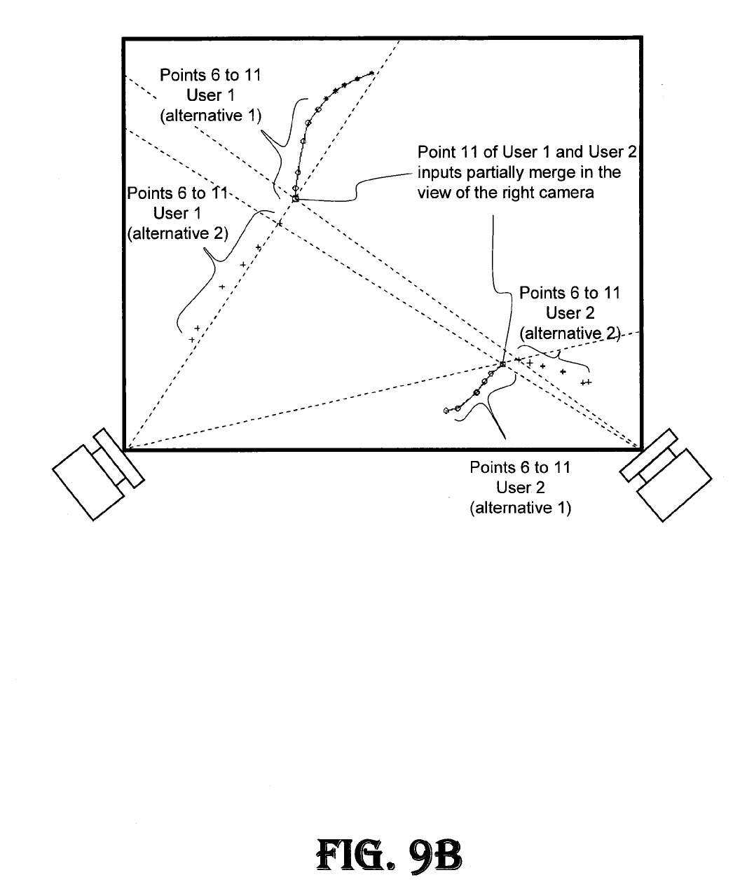

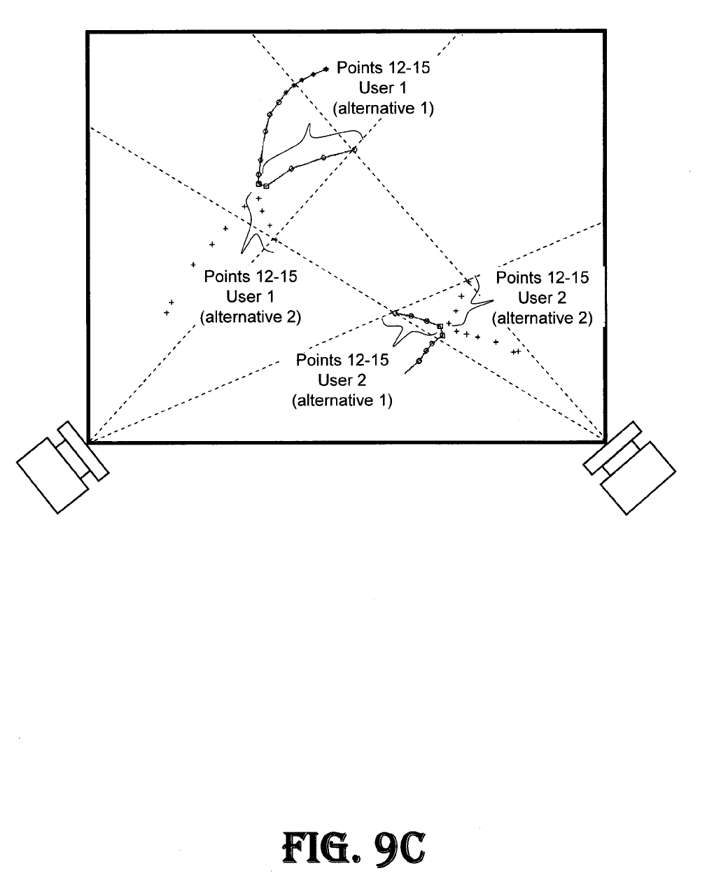

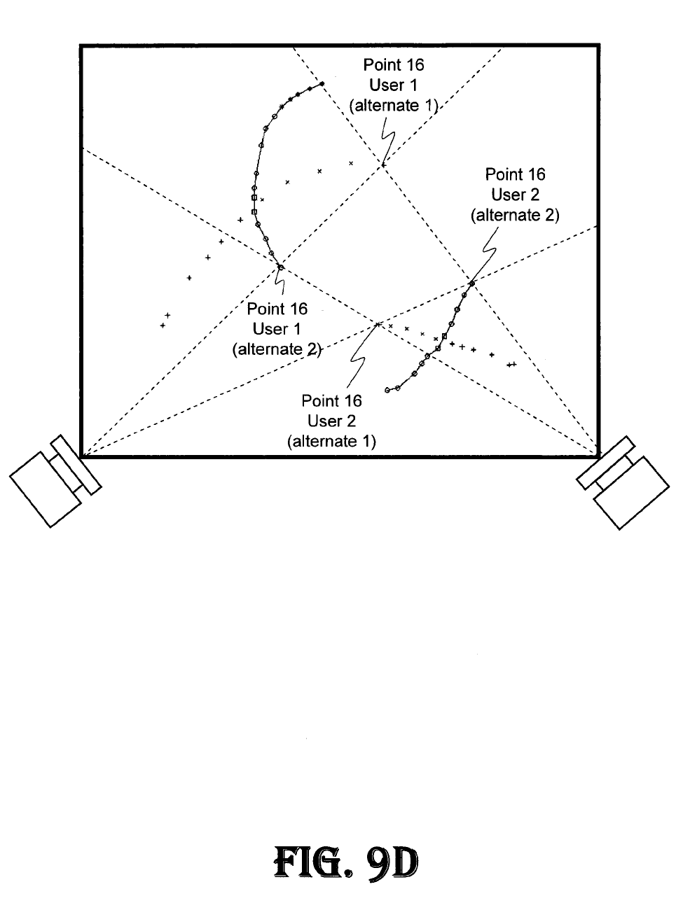

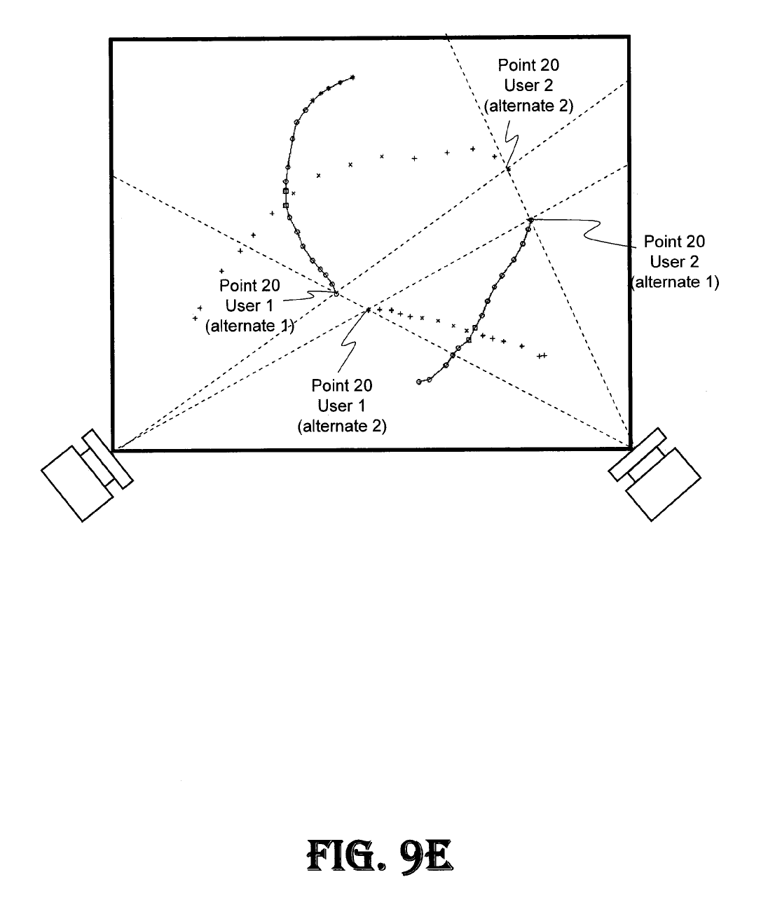

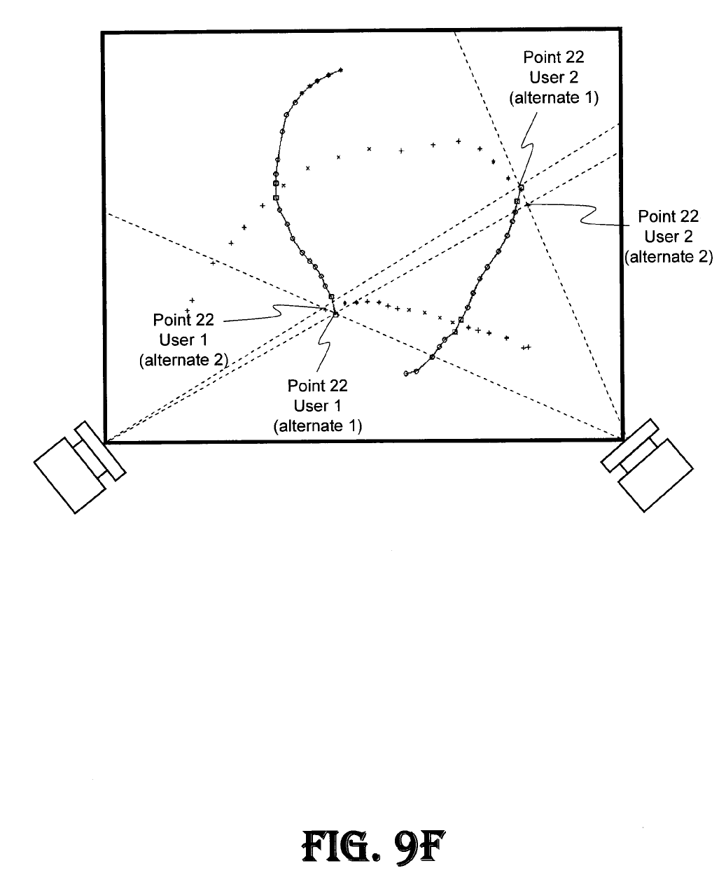

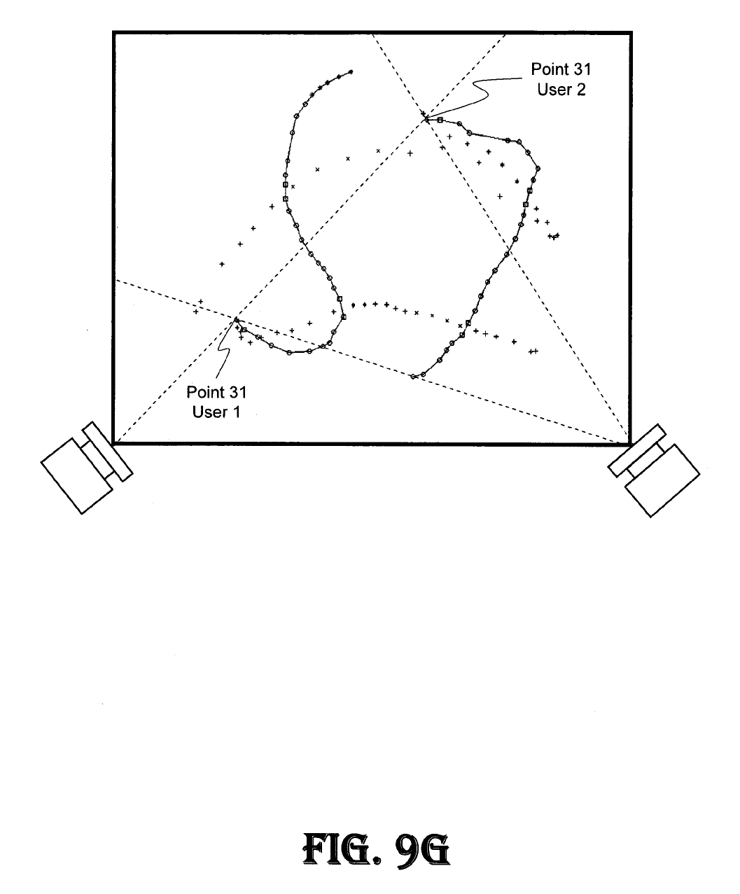

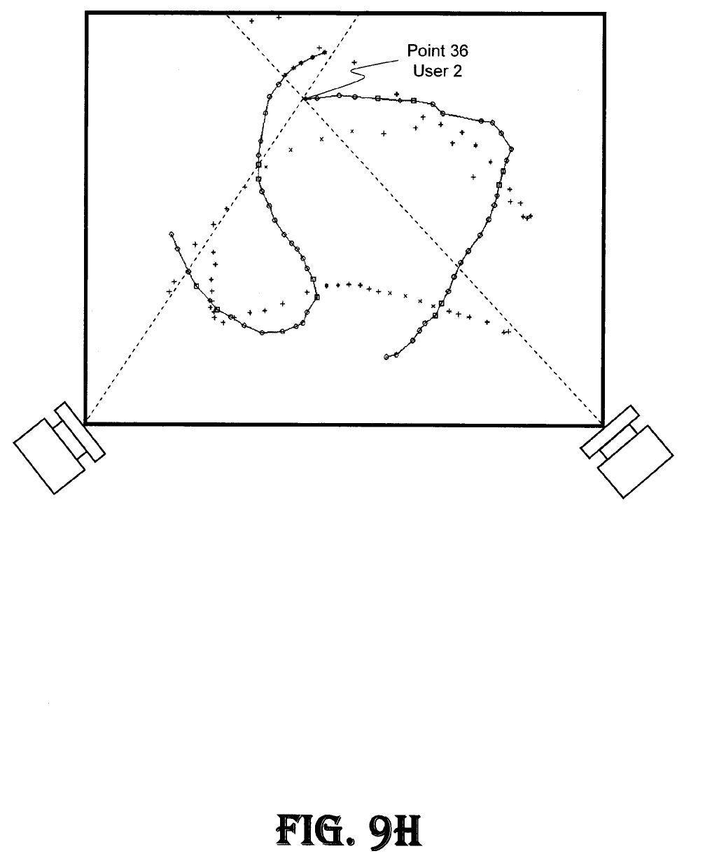

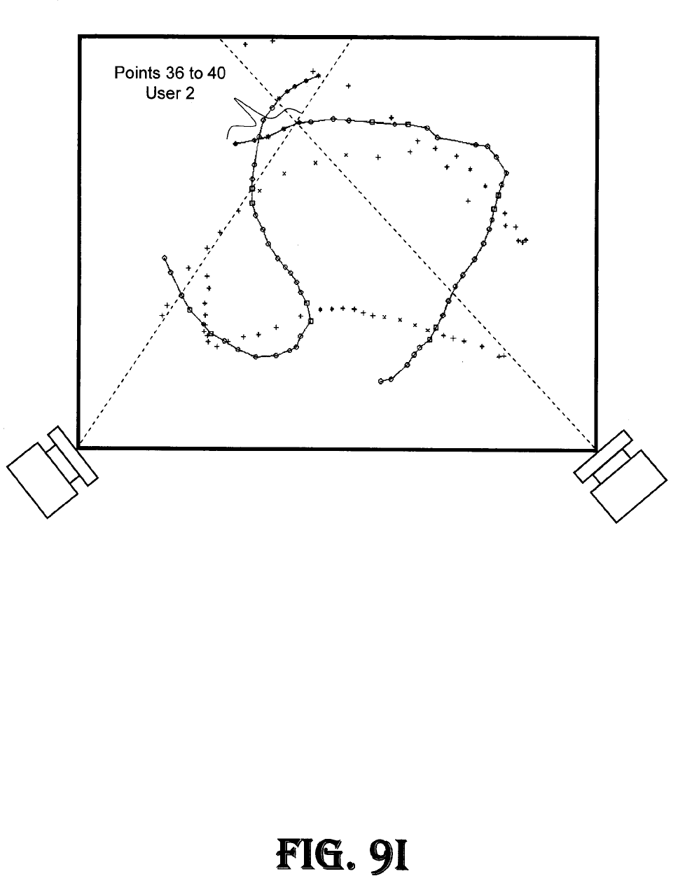

FIGS. 9A to 9I show an example of multiple pointer tracking on the touch surface 60. FIG. 9A shows the state of the system six frames after the initial touch. Pointer 1 (P1) has been in contact with the touch surface 60 for the previous five frames and is being tracked. Pointer 2 (P2) has just touched the touch surface 60. The four possible pointer touch solutions T1-T4 are computed and tracking is initiated. Because pointer P1 is already being tracked, the proper solution is obvious. In this instance, the left digital camera is designated to be the reference camera to keep track of which pointer is which because it has the larger angular spread. If an error correction occurs, the association of the reference camera is never changed. The association from the non-reference camera is always switched to correct the solution. This prevents pointer identifications from getting switched.

In FIG. 9B, the pointers are beginning to merge in the right camera view. When this happens, the paths from the phantom targets will come together with the paths from the real targets. After the observations separate in FIG. 9C, the error functions are reset and tracking determines which of the observations belongs to which pointer. In this case, state estimation fails and the phantom targets are reported as being the real pointers. Since the wrong path is being tracked, the error function will quickly show that a mistake is being made. In FIG. 9D, the error function has determined that a correction is necessary. Association in the non-reference right camera is switched, the incorrect path is erased (shown as plus signs in FIG. 9D), and the correct path is drawn. In FIG. 9E, the pointers are beginning to merge in the right reference camera view. At this point, the left camera can no longer be used as a reference because it is not reliable and the reference is moved to the right camera. The current solution on the right camera is now assumed to be the proper pointer association and any error correction will be implemented on the left camera. The error functions are reset to a state where an error correction will not be made until after another merge happens in the non-reference camera. This effectively locks in the decision.

In the FIG. 9F, the pointers have merged and then separated in the left camera and the error functions are reset to zero again. In this case, state estimation made the correct association and no error correction is necessary. In FIG. 9G, the pointers again merge in the left camera. In this case, pointer P2 is completely obscured from pointer P1 in the camera view and its position must be interpolated. In FIG. 9H, pointer P1 is removed from the touch surface. In FIG. 9I, tracking continues in the single pointer mode with pointer P2. No alternate solution is tracked.

The touch system 50 as described above comprises a pair of digital cameras 70 positioned adjacent the top corners of the touch surface 60. Those of skill in the art will appreciate that additional cameras 70 may be disposed about the periphery of the touch surface 60, especially when the touch surface is very large as described in above-incorporated U.S. patent Ser. No. 10/750,219 to Hill et al. Those of skill in the art will appreciate that the procedures described herein for scenarios with two pointers may be extended to scenarios with more than two pointers, and that the use of more than two image sensors will provide additional data for pointer disambiguation. Those of skill in the art will appreciate that the pointer ambiguity and occlusion resolution technique discussed above may be employed in virtually any machine vision touch system. For example, the pointer ambiguity and occlusion resolution technique may be employed in interactive input systems that make use of reflective, retro-reflective and/or absorbing bezels such as those described in U.S. patent application Ser. No. ______ (Not Available) to Jeremy Hansen et al. entitled “Interactive Input System and Bezel Therefor” filed on May 9, 2008, assigned to SMART Technologies ULC, the content of which is incorporated herein by reference.

As will be appreciated by those of skill in the art, the pointer may be a finger, a passive or active stylus or other object, a spot of light or other radiation or other indicator that can be seen by the cameras. Although the touch system is described as including digital cameras, other imaging devices such as for example linear optical sensors that are capable of generating an image may be employed.

The image generating device 58 may be a display unit such as for example, a plasma television, a liquid crystal display (LCD) device, a flat panel display device, a cathode ray tube (CRT) etc. In this case, the bezel 62 engages the display unit. The touch surface 60 may be constituted by the display surface of the display unit or by a pane surrounded by the bezel 62 that overlies the display surface of the display unit. Alternatively, the image generating device 58 may be a front or rear projection device that projects the computer-generated image onto the touch surface 60.

Although embodiments have been described above, those of skill in the art will also appreciate that variations and modifications may be made without departing from the spirit and scope thereof as defined by the appended claims.

What is claimed is:

1. A method of resolving ambiguities between at least two pointers in an interactive input system comprising:
capturing images of a region of interest;
processing image data to determine a plurality of potential targets for said at least two pointers within the region of interest and a current target location for each potential target, said plurality of potential targets comprising real and phantom targets;
tracking each potential target within said region of interest and calculating a predicted target location for each potential target; and
determining a pointer path associated at least with each real target.

2. The method of claim 1, wherein said tracking is performed using a predictive filter.

3. The method of claim 2, wherein the predictive filter is utilized to determine and correct each pointer path.

4. A method of resolving ambiguities between pointers in an interactive input system when at least one pointer is brought into a region of interest where at least one pointer already exists therein, the method comprising:
determining real and phantom targets associated with each pointer;
setting a real error function associated with said real targets;
setting a phantom error function associated with said phantom targets, wherein said phantom error function is set to a value different from said real error function; and
tracking and resolving each pointer based on their associated error functions.

5. The method of claim 4 further comprising comparing said real error function to said phantom error function to determine a pointer path for each target.

6. The method of claim 5, wherein if the real error function exceeds the phantom error function, the pointer path is corrected to correspond to a pointer path associated with the phantom target.

7. A method of resolving ambiguities between pointers in an interactive input system when at least two pointers are brought into a region of interest simultaneously:
determining real and phantom targets associated with each pointer contact;
setting error functions associated with each target; and
tracking and resolving each pointer contact through their associated error functions.

8. An interactive input system comprising:
at least two imaging devices having at least partially overlapping fields of view encompassing a region of interest; and
processing structure processing image data acquired by the imaging devices to track the position of at least two pointers within said region of interest and resolve ambiguities between the pointers.

9. The interactive input system of claim 8, wherein said processing structure comprises a target birth module for determining targets for said at least two pointers.

10. The interactive input system of claim 9, wherein said processing structure further comprises a target tracking module for tracking said targets in said region of interest.

11. The interactive input system of claim 10, wherein said processing structure further comprises a state estimation module for determining locations of said at least two pointers based on information from said target birth module, said target tracking module, and image data from said at least two imaging devices.

12. The interactive input system of claim 11, wherein said processing structure further comprises a blind tracking module for, when one of the at least two pointers becomes obscured for a prolonged period, determining a location for said obscured one of the at least two pointers.
